(19) United States
(12) Patent Application Publication
(10) Pub. No.: US 2009/0257220 A1
(43) Pub. Date: Oct. 15, 2009

(54) PLASTIC LED BULB

(75) Inventors: Ronald J. Lenk, Redwood City, CA (US); Carol Lenk, Redwood City, CA (US); Daniel Chandler, Menlo Park, CA (US)

Correspondence Address: BUCHANAN, INGERSOLL & ROONEY PC, POST OFFICE BOX 1404, ALEXANDRIA, VA, 22313-1404, US

(73) Assignee: SUPERBULBS, INC., Redwood City, CA (US)

(21) Appl. No.: 12/299,049

(22) PCT Filed: Apr. 27, 2007
(86) PCT No.: PCT/US07/10469

§ 371 Date: May 13, 2009

Related U.S. Application Data
(60) Provisional application No. 60/797,146, filed on May 2, 2006.

(51) Int. Cl. F21L 4/00; F21S 13/10; H01J 9/00

(52) U.S. Cl. 362/186; 362/363; 445/23

(57) ABSTRACT

An LED bulb having a bulb-shaped shell, a thermally conductive plastic material within the bulb-shaped shell, and at least one LED within the bulb-shaped shell. The bulb also includes a base, wherein the base is dimensioned to be received within a standard electrical socket.

### CROSS-REFERENCE TO RELATED APPLICATION

This application claims priority to U.S. Patent Provisional Application No. 60/797,146, filed May 2, 2006, which is incorporated herein by this reference in its entirety.

### FIELD OF THE INVENTION

The present invention relates to replacement of bulbs used for lighting by light emitting diode (LED) bulbs, and more particularly, to the efficient removal of the heat generated by the LEDs in order to permit the replacement bulb to match the light output of the bulb being replaced.

### BACKGROUND OF THE INVENTION

An LED consists of a semiconductor junction, which emits light due to a current flowing through the junction. At first sight, it would seem that LEDs should be able to make an excellent replacement for the traditional tungsten filament incandescent bulb. At equal power, they give far more light output than do incandescent bulbs, or, what is the same thing, they use much less power for equal light; and their operational life is orders of magnitude larger, namely, 10-100 thousand hours vs. 1-2 thousand hours.

However, LEDs have a number of drawbacks that have prevented them, so far, from being widely adopted as incandescent replacements. Among the chief of these is that, although LEDs require substantially less power for a given light output than do incandescent bulbs, it still takes many watts to generate adequate light for illumination. Whereas the tungsten filament in an incandescent bulb operates at a temperature of approximately 3000° (degrees) K, an LED, being a semiconductor, cannot be allowed to get hotter than approximately 120° C. The LED thus has a substantial heat problem: If operated in vacuum like an incandescent, or even in air, it would rapidly get too hot and fail. This has limited available LED bulbs to very low power (i.e., less than approximately 3W), producing insufficient illumination for incandescent replacements.

One possible solution to this problem is to use a large metallic heat sink, attached to the LEDs. This heat sink would then extend out away from the bulb, removing the heat from the LEDs. This solution is undesirable, and in fact has not been tried, because of the common perception that customers will not use a bulb that is shaped radically differently from the traditionally shaped incandescent bulb; and also from the consideration that the heat sink may make it impossible for the bulb to fit in to pre-existing fixtures.

This invention has the object of developing a light emitting apparatus utilizing light emitting diodes (LEDs), such that the above-described primary problem is effectively solved. It aims at providing a replacement bulb for incandescent lighting having a plurality of LEDs with a light output equal in intensity to that of an incandescent bulb, and whose dissipated power may be effectively removed from the LEDs in such a way that their maximum rated temperature is not exceeded. The apparatus includes a bulb-shaped shell, preferably formed of a plastic such as polycarbonate. The shell may be transparent, or may contain materials dispersed in it to disperse the light, making it appear not to have point sources of light, and may also contain materials dispersed in it to change the bluish color of the LED light to more yellowish color, more closely resembling the light from normal incandescent bulbs.

### SUMMARY OF THE INVENTION

In accordance with one embodiment, an LED bulb comprises: a bulb-shaped shell; a thermally conductive plastic material within the bulb-shaped shell; at least one LED within the bulb-shaped shell; and a base, wherein the base is dimensioned to be received within an electrical socket.

In accordance with another embodiment, a method of manufacturing an LED bulb comprises: creating a plastic bulb-shaped shell; filling the shell with a plastic material, wherein the plastic material is thermally conductive; installing at least one LED in the plastic material prior to curing the plastic material; and curing the plastic material.

In accordance, a method of manufacturing an LED bulb comprising: creating a plastic bulb-shaped shell; installing at least one LED in the plastic bulb-shaped shell; filling the shell with a plastic material, wherein the plastic material is thermally conductive; and curing the plastic material.

In accordance with a further embodiment, a method of manufacturing an LED incandescent bulb replacement, comprises: creating a plastic incandescent bulb-shaped shell; filling the shell with a plastic material and wherein the plastic material is thermally conductive, wherein the plastic material cures at a temperature below that which might damage the LEDs; installing at least one LED in the plastic material prior to curing; and curing the plastic material after the filling means and the installing means are completed.

In accordance with a further embodiment, a method of manufacturing an LED incandescent bulb replacement, comprises: creating a plastic incandescent bulb-shaped shell; installing at least one LED within the incandescent bulb-shaped shell; filling the shell with a plastic material and wherein the plastic material is thermally conductive, wherein the plastic material cures at a temperature below that which might damage the LEDs; and curing the plastic material after the filling means and the installing means are completed.

In accordance with another embodiment, an LED bulb comprises: a thermally conductive plastic bulb; at least one LED within the thermally conductive plastic bulb; and a base, wherein the base is dimensioned to be received within an electrical socket.

In accordance with a further embodiment, a method of manufacturing an LED incandescent bulb replacement, comprises: installing at least one LED into a bulb shaped mold; filling the mold with a thermally conductive plastic material; and curing the plastic material, wherein the plastic material cures at a temperature below that which might damage the at least one LED.

In accordance with a further embodiment, a method of manufacturing an LED bulb comprises: creating a plastic bulb-shaped shell; filling the shell with a thermally conductive material; installing at least one LED in the thermally conductive material prior to gelling the thermally conductive material; and gelling the thermally conductive material.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional view of an LED replacement bulb showing the light-emitting portion of the LED mounted in a plastic material.

FIG. 2 is a cross-sectional view of an LED replacement bulb showing the LED embedded in a plastic shell, while remaining in thermal contact with a plastic material.

FIG. 3 is a cross-sectional view of an LED replacement bulb showing a plurality of LEDs mounted in a plastic material.

FIG. 4 is a cross-sectional view of an LED replacement bulb showing the LED in a thermally conductive plastic bulb.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

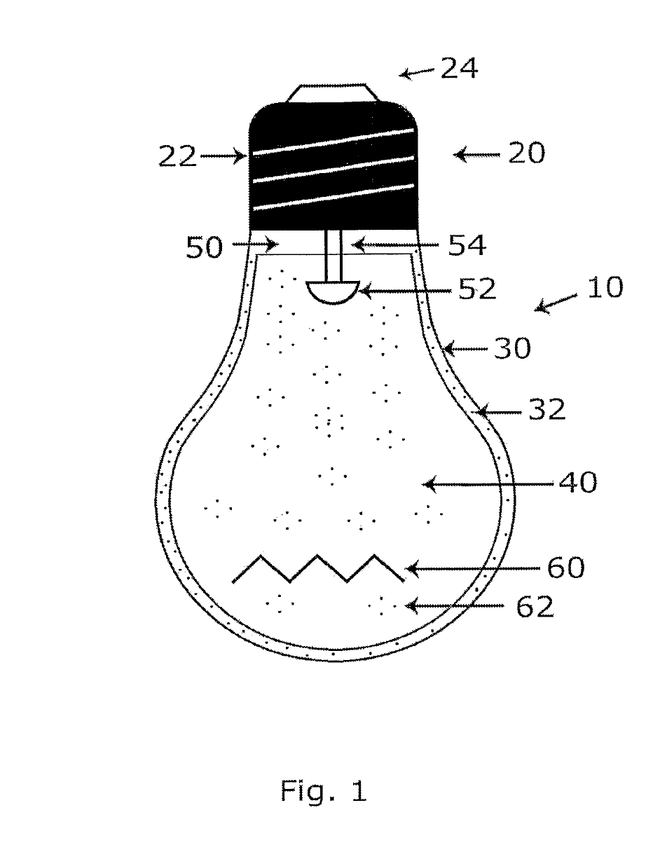

FIG. 1 is a cross-sectional view of an LED replacement bulb 10 showing the light-emitting portion of the LED mounted in a plastic material according to one embodiment. As shown in FIG. 1, the LED replacement bulb 10 includes a screw-in base 20, a plastic shell 30, an inner portion 40 containing a transparent or translucent thermally conductive material, which may be any suitable plastic material 60, and at least one LED 50. It can be appreciated that the shell 30 (or enclosure) may be any shape, or any of the other conventional or decorative shapes used for bulbs, including but not limited to spherical, cylindrical, and “flame” shaped shells 30. Alternatively, the shell 30 can be a tubular element, as used in fluorescent lamps or other designs.

The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket, which is configured to receive an incandescent bulb, such as a bayonet style base. The screw-in base 20 makes electrical contact with the AC power in a socket through its screw threads 22 and its base pin 24. Inside the screw-in base 20 is a power supply (not shown) that converts the AC power to a form suitable for driving the at least one LED 50.

As shown in FIG. 1, the plastic shell 30 entirely encases the plastic material 60 within the inner portion 40 of the LED replacement bulb 10. The shell 30 also encases at least the light-emitting portion 52 of the at least one LED 50, with the connecting wires 54 coming out through the shell 30 through a sealed connection to the power supply.

The bulb-shaped shell 30 is preferably formed of a plastic, liquid plastic or plastic like material, such as polycarbonate. However, it can be appreciated that shell 30 can be constructed of any suitable plastic material. In addition, the shell 30 is preferably transparent, however, it can be appreciated that the shell can also contain a dispersion material 32 dispersed throughout the shell 30. The dispersion material 32 is preferably configured to disperse the light from the light-emitting portion 52 of the LED 50. The dispersion of the light source from the light-emitting portion 52 prevents the bulb 10 from appearing to have a point source or a plurality of point sources of light with a plurality of LEDs 50. It can be appreciated that the shell 30 can also contain dispersion material 32 to assist with changing the bluish color of a typical LED die to a more yellowish color, which more closely resembles the light from normal incandescent bulbs.

In another embodiment, the shell 30 and/or the plastic material 60 can include a plurality of bubbles (not shown), wherein the bubbles disperse the light from the at least one LED 50. In yet another embodiment, a dye (not shown) can be added to the shell 30 or the plastic material 60 within the shell 30, wherein the dye shifts the light of the at least one LED 50 from a first color spectrum to a second color spectrum.

As shown in FIG. 1, the shell 30 is filled with a thermally conductive plastic material 60, such as a liquid plastic or other suitable material. In a preferred embodiment, the plastic material 60 cures at a temperature below that which can cause damage to the LEDs 50. The plastic material 60 may also be of the same material as the shell. The plastic material 60 may also be a gel. During use, the plastic material 60 acts as the means to transfer the heat power generated by the at least one LED 50 to the shell 30, where it can be removed by radiation and convection, as in a normal incandescent bulb. The plastic material 60 can be transparent, or may contain a dispersion material 62 to assist with dispersing the light from the light-emitting portion 52 of the LED 50. The dispersion material prevents the bulb 10 from appearing to have a point source or a plurality of point sources of light with a plurality of LEDs 50. In addition, the dispersion material 62 dispersed in the plastic material 62 may be used to change the bluish color of the light-emitting portion 52 of the LED 50 to a more yellowish color, more closely resembling the light from normal incandescent bulbs. The plastic material 60 is also preferably electrically insulating.

The at least one LED 50 is preferably installed in the plastic material prior to the curing of the plastic material or prior to the addition of plastic material. Once the at least one LED 50 is installed in the plastic material 60, but still prior to curing, the electrical contacts for powering the LEDs 50 are brought out. The leads are connected to the power source for the LEDs 50, which will typically be included inside the remainder of the bulb 10. The power source is preferably designed to be compatible with pre-existing designs, so that the bulb 10 may directly replace traditional bulbs without requiring any change in the pre-existing fixture. The bulb 10 has metallic contacts mounted to it, which will provide the power to the power source for the at least one LED 50.

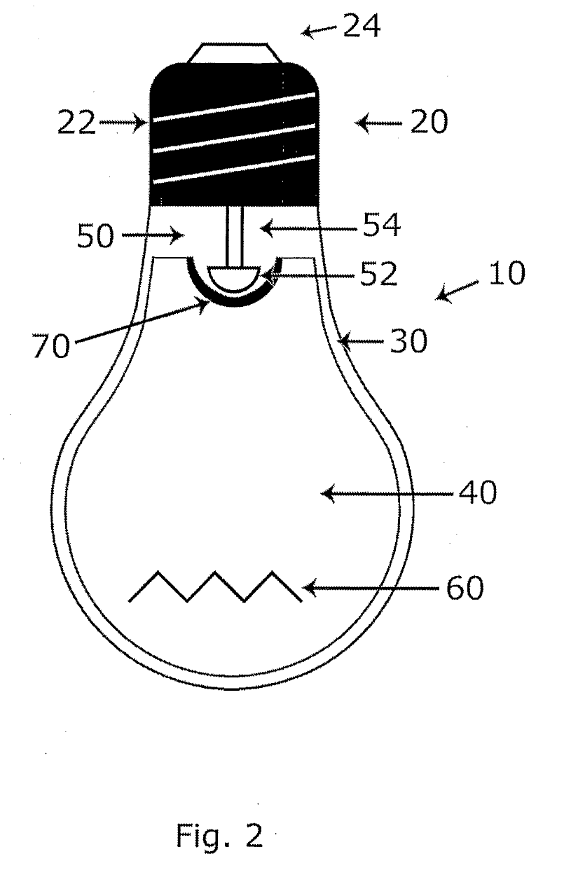

FIG. 2 is a cross-sectional view of an LED replacement bulb 10 showing at least one LED 50 embedded in the plastic shell 30, while remaining in thermal contact with the plastic material 60. The LED replacement bulb 10 can include a screw-in base 20, a shell 30, an inner portion 40 containing a plastic material 60, and at least one LED 50 with a light-emitting portion 52 and a pair of connecting wires 54. The screw-in base 20 makes electrical contact with the AC power in a socket through its screw threads 22 and its base pin 24 Inside the screw-in base 20 is a power supply (not shown) that converts the AC power to a form suitable for driving the at least one LED 50. The LED or LEDs 50 are comprised of two parts, the connecting wires 54 that connect them to the power supply, and the light-emitting portion 52. The shell 30 entirely encases the plastic material 40. The shell 30 also encases the at least one LED 50, with the connecting wires 54 connecting to the power supply. In this embodiment, the at least one LED 50 is thermally connected to the plastic material 40 through a thin shell-wall 70. The shell-wall 70 provides a low thermal resistance path to the plastic material 60 for the heat dissipated by the at least one LED 50.

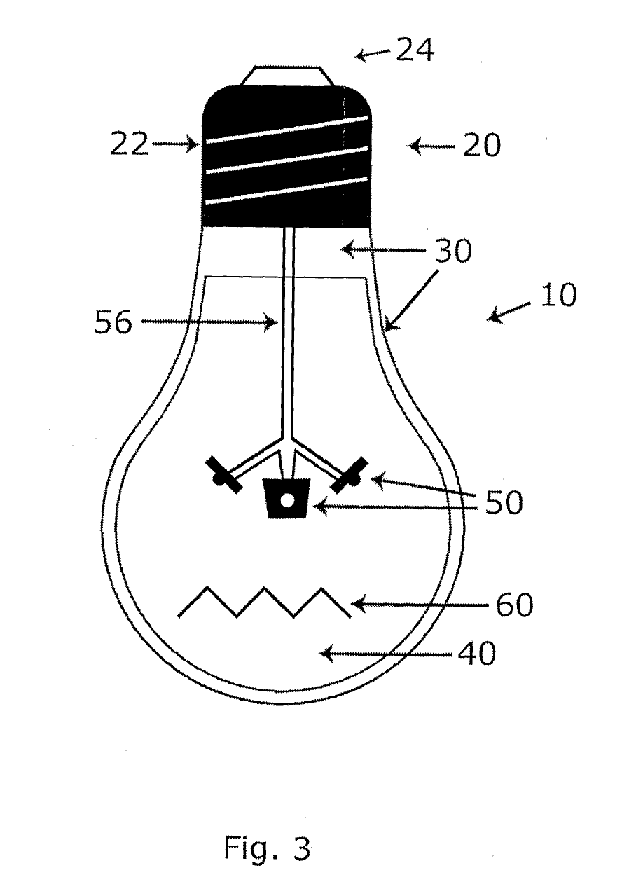

FIG. 3 is a cross-sectional view of an LED replacement bulb 10 showing a plurality of LEDs 50 mounted in the plastic material 60 according to a further embodiment. The LED replacement bulb 10 includes a screw-in base 20, a shell 30, an inner portion 40 containing a plastic material 60, and a plurality of LEDs 50 with an LED support 56. The screw-in base 20 makes electrical contact with the AC power in a socket through its screw threads 22 and its base pin 24. Inside the screw-in base 20 is a power supply (not shown) that converts the AC power to a form suitable for driving the at least one LED 50.

The plurality of LEDs 50 in this embodiment are preferably at least 3 or 4 LED dies arranged to distribute the light source in a suitable configuration. In one embodiment, the plurality of LEDs 50 can be arranged in a tetrahedral configuration. The at least one LED or the plurality of LEDs 50 are comprised of two parts, the connecting wires 54 that connect them to the power supply, and the LED or LEDs 50 themselves. The connecting wires 56 are stiff enough to function as support for the LED or LEDs 50, and also form the interconnects between the LEDs 50 when there are multiple devices. The shell 30 entirely encases the plastic material 60. The shell 30 also encases the LED or LEDs 50, with the connecting wires 56 coming out through the shell 30 through a sealed connection to the power supply. It can be appreciated that in another embodiment, the support may be a different material from the interconnections or connections.

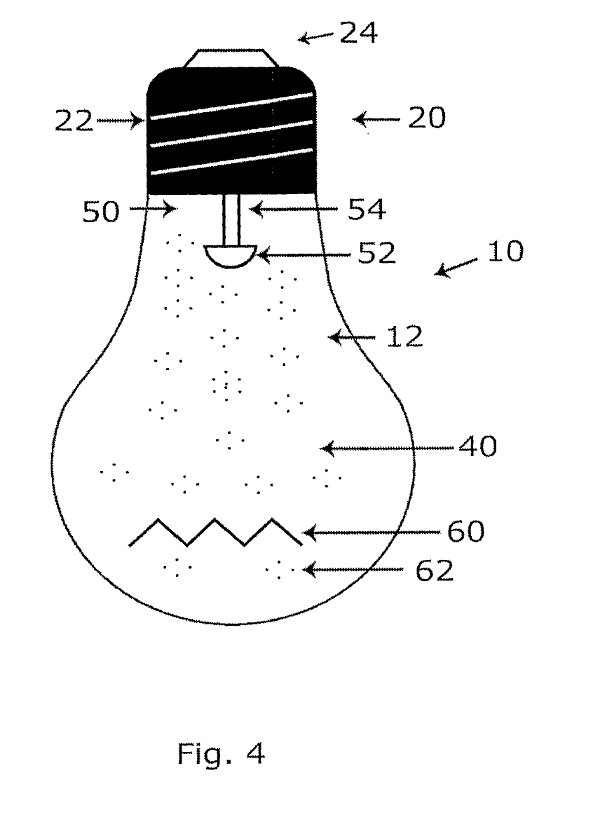

FIG. 4 is a cross-sectional view of an LED replacement bulb 10 showing the LED 50 in a thermally conductive plastic bulb 12. As shown in FIG. 4, the LED bulb 10 can include a thermally conductive plastic bulb 12, at least one LED 50 within the bulb 12, and a screw-in base 20. The base 20 include a series of screw threads 22 and a base pin 24, wherein the screw threads 22 and the base pin 24 are dimensioned to be received within a standard electrical socket. Typically, if the plastic material 60 and the shell 30 as shown in FIG. 1 of the bulb 10 are made of the same material, instead of a defined separation between the shell 30 and the thermally conductive plastic material 60, the shell 30 and the thermally conductive plastic material 60 can form a thermally conductive bulb 12. In addition, if the same material is used for the shell 30 and the plastic material 60, the LED bulb 10 can be formed by placing the screw-in base 20, which includes the series of screw threads 22 and the base pin 24, and the at least one LED 50 into a mold and adding the plastic material 60 thereto. The plastic material 60 is then cured at a temperature below that which might damage the at least one LED 50. Subsequent processing to the plastic material 60 may result in the formation of a shell subsequent to the curing step. Alternately, subsequent processing to the plastic material 60 may add a shell subsequent to the curing step.

It can be appreciated that the LED replacement bulbs as shown in FIGS. 1-4 are shown as replacement bulbs for standard incandescent bulbs, however, the bulbs 10 and methods as set forth herein can be used for any lighting system, including flashlights, headlights for automobiles and/or motorcycles, and/or lanterns.

It will be also be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1.-130. (canceled)

131. An LED bulb comprising:
a shell;
a thermally conductive plastic material within the shell;
at least one LED within the shell; and
a base configured to fit within a socket.

132. The LED bulb as set forth in claim 131, wherein the base comprises a series of screw threads and a base pin, wherein the screw threads and base pin are dimensioned to be received within a standard electrical socket.

133. The LED bulb as set forth in claim 131, wherein the shell is a plastic material.

134. The LED bulb as set forth in claim 131, wherein at least a portion of the at least one LED is mounted within the thermally conductive material.

135. The LED bulb as set forth in claim 131, wherein the at least one LED is thermally connected to the thermally conductive material through a thin shell-wall.

136. The LED bulb as set forth in claim 131, further comprising a power source, wherein the power source for the at least one LED is contained within the bulb, and wherein the power source for the at least one LED is compatible with pre-existing power sources, permitting the bulb to be used in pre-existing fixtures.

137. The LED bulb as set forth in claim 131, further comprising a dispersion material within the shell, wherein the dispersion material disperses the light from the at least one LED.

138. The LED bulb as set forth in claim 131, wherein the shell disperses the light from the at least one LED.

139. The LED bulb as set forth in claim 131, further comprising a dispersion material within the thermally conductive material, wherein the dispersion material disperses the light from the at least one LED.

140. The LED bulb as set forth in claim 131, wherein the thermally conductive material has the characteristics to disperse and/or color shift the light.

141. The LED bulb as set forth in claim 131, further comprising a plurality of bubbles within the thermally conductive material, wherein the bubbles disperse the light from the at least one LED.

142. The LED bulb as set forth in claim 131, further comprising a color shifting material within the shell, wherein the color shifting material shifts light from the LED from a first color spectrum to a second color spectrum.

143. The LED bulb as set forth in claim 131, further comprising a dye added to the shell, wherein the dye shifts the light of the at least one LED from a first color spectrum to a second color spectrum.

144. The LED bulb as set forth in claim 131, further comprising a color shifting material within the thermally conductive material, wherein the color shifting material shifts light from the LED from a first color spectrum to a second color spectrum.

145. The LED bulb as set forth in claim 131, further comprising a dye added to the thermally conductive material, wherein the dye shifts the light of the at least one LED from a first color spectrum to a second color spectrum.

146. The LED bulb as set forth in claim 131, wherein the thermally conductive material is a gel.

147. The LED bulb as set forth in claim 131, wherein the thermally conductive material is a liquid plastic.

148. The LED bulb as set forth in claim 131, wherein the shell and the thermally conductive material are of the same material.

149. A method of manufacturing an LED bulb comprising:
creating a shell;
installing at least one LED in the shell;
filling the shell with a thermally conductive material; and
curing the thermally conductive material.

150. The method as set forth in claim 149, further comprising attaching a base to the shell, wherein the base is dimensioned to be received within a standard electrical socket.

151. The method as set forth in claim 149, further comprising installing a power source within the bulb, and wherein the power source for the at least one LED is compatible with pre-existing power sources, permitting the bulb to be used in pre-existing fixtures.

152. The method as set forth in claim 149, further comprising a means to disperse and/or means to color shift the light within the thermally conductive material.

153. The method as set forth in claim 149, further comprising a means to disperse and/or means to color shift the light contained within the shell.

154. The method as set forth in claim 149, wherein the shell and the thermally conductive material are of the same material.

155. A method of manufacturing an LED bulb, comprising:
creating a shell;
filling the shell with a thermally conductive material;
installing at least one LED in the thermally conductive material; and
curing the thermally conductive material after the filling of the shell and the installing of the at least one LED are completed.

156. The method as set forth in claim 155, further comprising;
attaching a base to the shell, wherein the base is dimensioned to be received within a standard electrical socket; and
installing a power source within the bulb, and wherein the power source for the at least one LED is compatible with pre-existing power sources permitting the bulb to be used in pre-existing fixtures.

157. A method of manufacturing an LED bulb comprising:
creating a shell;
filling the shell with a thermally conductive material;
installing at least one LED in the thermally conductive material; and
gelling the thermally conductive material.

158. The method as set forth in claim 157, further comprising;
attaching a base to the shell, wherein the base is dimensioned to be received within a standard electrical socket; and
installing a power source within the bulb, and wherein the power source for the at least one LED is compatible with pre-existing power sources permitting the bulb to be used in pre-existing fixtures.

159. The method as set forth in claim 157, wherein the thermally conductive material has the characteristics to disperse and/or color shift the light.

160. A method of manufacturing an LED bulb comprising:
creating a shell;
installing at least one LED within the shell;
filling the shell with a thermally conductive material; and
gelling the thermally conductive material.

161. The method as set forth in claim 160, further comprising;
attaching a base to the shell, wherein the base dimensioned to be received within a standard electrical socket; and
installing a power source within the bulb, and wherein the power source for the at least one LED is compatible with pre-existing power sources permitting the bulb to be used in pre-existing fixtures.

162. The method as set forth in claim 160, wherein the thermally conductive material has the characteristics to disperse and/or color shift the light.

163. A method of manufacturing an LED bulb comprising:
installing at least one LED into a mold;
filling the mold with a thermally conductive material; and
curing the thermally conductive material.

164. The method as set forth in claim 163, further comprising processing the outside of the bulb to produce a shell.

165. The method as set forth in claim 163, further comprising adding a shell to the bulb.

166. A method of manufacturing an LED bulb comprising:
installing at least one LED into a mold;
filling the mold with a thermally conductive material; and
gelling the thermally conductive material.

167. The method as set forth in claim 166, further comprising processing the outside of the bulb to produce a shell.

168. The method as set forth in claim 166, further comprising adding a shell to the bulb.

169. A method of manufacturing an LED bulb comprising:
creating a shell;
installing at least one LED in the shell; and
filling the shell with a gel.

170. The method as set forth in claim 169, further comprising a dispersion material within the gel, wherein the dispersion material disperses the light from the at least one LED.

171. The method as set forth in claim 169, wherein the gel has the characteristics to disperse and/or color shift the light.

172. The method as set forth in claim 169, further comprising a plurality of bubbles within the gel, wherein the bubbles disperse the light from the at least one LED.

173. The method as set forth in claim 169, further comprising a color shifting material within the shell, wherein the color shifting material shifts light from the LED from a first color spectrum to a second color spectrum.

174. The method as set forth in claim 169, further comprising adding a dye to the shell, wherein the dye shifts the light of the at least one LED from a first color spectrum to a second color spectrum.

175. The method as set forth in claim 169, further comprising a color shifting material within the gel, wherein the color shifting material shifts light from the LED from a first color spectrum to a second color spectrum.

176. The method as set forth in claim 169, further comprising adding a dye to the gel, wherein the dye shifts the light of the at least one LED from a first color spectrum to a second color spectrum.

177. A method of manufacturing an LED bulb comprising:
creating a shell;
filling the shell with gel; and
installing at least one LED in the gel filled shell.

178. The method as set forth in claim 177, further comprising a dispersion material within the gel, wherein the dispersion material disperses the light from the at least one LED.

179. The method as set forth in claim 177, wherein the gel has the characteristics to disperse and/or color shift the light.

180. The method as set forth in claim 177, further comprising a plurality of bubbles within the gel, wherein the bubbles disperse the light from the at least one LED.

181. The method as set forth in claim 177, further comprising a color shifting material within the shell, wherein the color shifting material shifts light from the LED from a first color spectrum to a second color spectrum.

182. The method as set forth in claim 177, further comprising adding a dye to the shell, wherein the dye shifts the light of the at least one LED from a first color spectrum to a second color spectrum.

183. The method as set forth in claim 177, further comprising a color shifting material within the gel, wherein the color shifting material shifts light from the LED from a first color spectrum to a second color spectrum.

184. The method as set forth in claim 177, further comprising adding a dye to the gel, wherein the dye shifts the light of the at least one LED from a first color spectrum to a second color spectrum.
